(19) United States
(12) Patent Application Publication
(10) Pub. No.: US 2026/0237123 A1
(43) Pub. Date: Aug. 13, 2026

(54) ELECTRONIC DEVICE AND METHOD FOR GENERATING ARTIFICIAL INTELLIGENCE IMAGE BY USING USER INPUT

(71) Applicant: Samsung Electronics Co., Ltd., Suwon-si (KR)

(72) Inventors: Chulju YANG, Suwon-si (KR); Moonsoo KIM, Suwon-si (KR); Sungguk NAM, Suwon-si (KR); Jihun MUN, Suwon-si (KR); Nagyeom YOO, Suwon-si (KR)

(21) Appl. No.: 19/633,123

(22) Filed: Mar. 30, 2026

Related U.S. Application Data
(63) Continuation of application No. PCT/KR2024/018647, filed on Nov. 22, 2024.

(30) Foreign Application Priority Data
Jan. 12, 2024 (KR) 10-2024-0005589
Feb. 20, 2024 (KR) 10-2024-0024120

(51) Int. Cl. G06T 11/60; H04N 23/63

(52) U.S. Cl. CPC G06T 11/60; H04N 23/632; G06T 2200/24

(57) ABSTRACT

An electronic device is provided. The electronic device includes an image sensor, a display, memory, including one or more storage media, storing one or more computer programs, and one or more processors communicatively coupled to the image sensor, the display, and the memory, wherein the one or more computer programs include computer-executable instructions that, when executed by the one or more processors individually or collectively, cause the electronic device to display a preview image obtained from the image sensor on a display, receive a first user input for the preview image through the display, generate at least one artificial intelligence (AI) graphic object based on at least a portion of the first user input, display the at least one AI graphic object on the preview image, and generate an AI image based on an image captured in response to a second user input and at least a portion of the at least one AI graphic object.

### CROSS-REFERENCE TO RELATED APPLICATION(S)

This application is a continuation application, claiming priority under 35 U.S.C. § 365(c), of an International application No. PCT/KR2024/018647, filed on Nov. 22, 2024, which is based on and claims the benefit of a Korean patent application number 10-2024-0005589, filed on Jan. 12, 2024 in the Ministry of Intellectual Property (MOIP), and of a Korean patent application number 10-2024-0024120, filed on Feb. 20, 2024, in the Ministry of Intellectual Property (MOIP), the disclosure of each of which is incorporated by reference herein in its entirety.

### BACKGROUND

### 1. Field

The disclosure relates to an electronic device for generating an artificial intelligence (AI) image using a user input.

### 2. Description of Related Art

With the advancement of artificial intelligence (AI) technologies, innovative changes are also taking place in the field of image processing. In particular, AI images are one of the fields attracting attention in the field of computer vision. AI images are generated through the ability of computers to interpret and understand images using machine learning and deep learning algorithms.

When a prompt is configured and input using a text, an AI model may generate an image that matches the prompt. In addition, when a user designates an area desired for generation and then configures and inputs a prompt using a text in the same manner, the AI model may insert a generated image into the designated area.

In order to edit a picture using a generative AI model, a user first writes an intent for generation as a text to configure a prompt and generate an image. At this time, if the AI model does not interpret the written prompt as intended by the user, an image different from the user intent may be obtained for the prompt. The generation may be performed only with an input prompt without considering surrounding objects, and thus, an awkward image that does not match the surrounding objects may be generated.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and method for generating an image using a user input.

Additional aspects will be set forth in part in the description which follows and, in part, will be apparent from the description, or may be learned by practice of the presented embodiments.

In accordance with an aspect of the disclosure, an electronic device is provided. The electronic device includes an image sensor, a display, memory, including one or more storage media, storing one or more computer programs, and one or more processors communicatively coupled to the image sensor, the display, and the memory, wherein the one or more computer programs include computer-executable instructions that, when executed by the one or more processors individually or collectively, cause the electronic device to display a preview image obtained from the image sensor on the display, receive a first user input for the preview image through the display, generate at least one artificial intelligence (AI) graphic object based on at least a portion of the first user input, display the at least one AI graphic object on the preview image, and generate an AI image based on an image captured in response to a second user input and at least a portion of the at least one AI graphic object.

In accordance with another aspect of the disclosure, a method performed by an electronic device with a display is provided. The method includes displaying a preview image of a camera on the display, receiving a first user input for the preview image, generating at least one artificial intelligence (AI) graphic object based on at least a portion of the first user input, and displaying the at least one AI graphic object on the preview image.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include displaying a preview image obtained from an image sensor of the electronic device on a display of the electronic device, receiving a first user input for the preview image through the display, generating at least one artificial intelligence (AI) graphic object based on at least a portion of the first user input, displaying the at least one AI graphic object on the preview image, and generating an AI image based on an image captured in response to a second user input and at least a portion of the at least one AI graphic object.

In the method of generating the AI image according to an embodiment, when capturing a picture, a user easily obtains a picture desired by the user using a generative AI model more easily through an interaction (drawing) on a captured screen without going through a separate editing process.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a schematic configuration of an electronic device according to an embodiment of the disclosure;

FIG. 2 is a flowchart illustrating a flow of generating an artificial intelligence (AI) image according to an embodiment of the disclosure;

FIG. 3 is a diagram illustrating an example of generating an AI image through drawing according to an embodiment of the disclosure;

FIG. 4 is a diagram illustrating an example of generating an AI image by selecting and changing an object added by drawing among samples according to an embodiment of the disclosure;

FIG. 5 is a diagram illustrating an example of generating an AI image by changing an object added by drawing by inputting a text according to an embodiment of the disclosure;

FIG. 6 is a diagram illustrating an example of generating an AI image using a stored template according to an embodiment of the disclosure;

FIG. 7 is a diagram illustrating an example of generating an AI image by designating an object to be drawn according to an embodiment of the disclosure;

FIG. 8 is a diagram illustrating an example of modifying an AI image by loading a stored AI image according to an embodiment of the disclosure;

FIG. 9 is a diagram illustrating an example of fixing a preview and generating an AI image through drawing according to an embodiment of the disclosure;

FIG. 10 is a diagram illustrating a schematic configuration of an electronic device for generating an AI image according to an embodiment of the disclosure; and

FIG. 11 is a block diagram illustrating an electronic device in a network environment according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terminology used herein is for the purpose of describing particular embodiments only and is not to be limiting of the embodiments. It will be further understood that the terms “comprises/comprising” or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In the descriptions of the embodiments referring to the accompanying drawings, like reference numerals refer to like elements and any repeated description related thereto will be omitted. In the description of embodiments, detailed description of well-known related structures or functions will be omitted when it is deemed that such description will cause ambiguous interpretation of the disclosure.

In addition, the terms first, second, A, B, (a), and (b) may be used to describe components of the embodiments. These terms are used only for the purpose of discriminating one component from another component, and the nature, the sequences, or the orders of the components are not limited by the terms. When one component is described as being “connected,” “coupled,” or “attached” to another component, it should be understood that one component may be connected or attached directly to another component, and an intervening component may also be “connected,” “coupled,” or “attached” to the components.

Components included in an embodiment and components that have common functions will be described using the same names in other embodiments. Unless stated otherwise, the description of any one embodiment may be applied to other embodiments, and the specific description of the repeated configuration will be omitted.

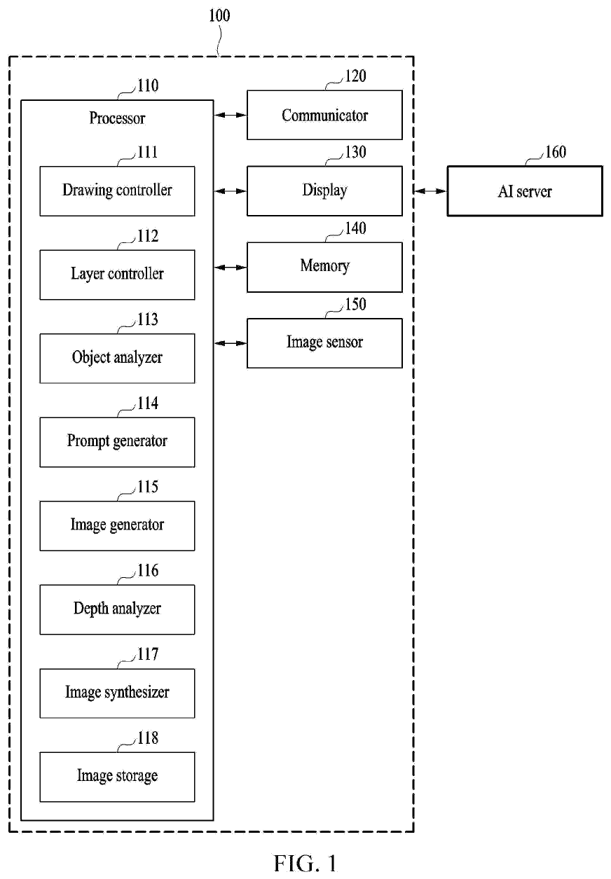

Hereinafter, a device and method for generating an artificial intelligence (AI) image using a user input according to an embodiment of the disclosure are described in detail with reference to FIGS. 1 to 11.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

FIG. 1 is a diagram illustrating a schematic configuration of an electronic device according to an embodiment of the disclosure.

Referring to FIG. 1, an electronic device 100 may include a processor 110, a communicator 120, a display 130, a memory 140, and an image sensor 150.

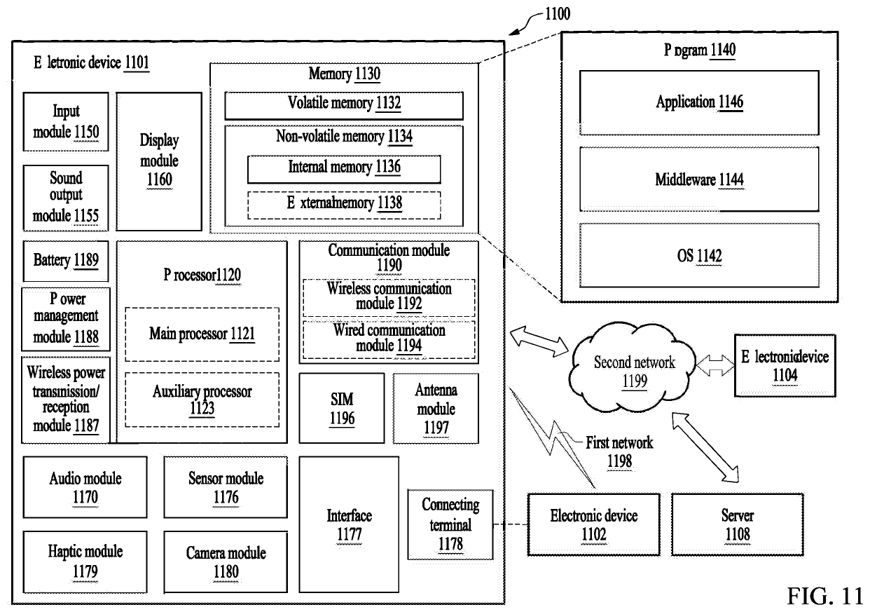

The communicator 120 is a communication interface device including a receiver and a transmitter, and transmits and receives data wired or wirelessly. The communicator 120 may communicate with an AI server 160 that generates an AI image. At this time, the communicator 120 may be a component corresponding to a communication module 1190 of FIG. 11, and the AI server 160 may be a component corresponding to a server 1108 of FIG. 11.

The display 130 may display state information (or an indicator), limited numbers and characters, moving pictures, and still pictures, which are generated during an operation of the electronic device 100. Additionally, the disclosure may display a preview image, at least one AI graphic object, and an AI image.

The display 130 of the disclosure may be a touch screen capable of receiving a touch input. A touch screen includes a display portion that performs a screen output function and a touch sensor that performs a touch input function. Such a touch screen may have a structure in which a touch sensor is disposed on a front surface of the display portion. The display portion may be formed of a liquid crystal display (LCD), organic light emitting diodes (OLEDs), or the like. The touch sensor performs a function of receiving a touch input, that is, a function of receiving a touch event, a double touch event, a touch movement event, a touch release event, or the like. That is, the touch sensor may generate a touch event when an object, for example, a user's finger, touches the touch sensor, and transmit the generated touch event to the processor 110. When a finger moves in a predetermined direction on the touch sensor while maintaining a touched state, the touch sensor may generate the touch movement event, and transmit the touch movement event to the processor 110. The touch movement event may be divided into a flick event with a movement speed greater than or equal to a preset threshold value and a drag event with the movement speed less than or equal to the threshold value. In addition, after the touch event or the touch movement event is generated, when the user's finger moves away from the touch sensor, the touch sensor may generate a touch release event, and transmit the touch release event to the processor 110. Such a touch sensor may be formed by a pressure-sensitive, infrared, or capacitive method. Hereinafter, for convenience of description, the display 130 will be described in parallel with the touch screen. The display 130 may be a component corresponding to a display module 1160 of FIG. 11.

The memory 140 may store an operating system (OS) for controlling the overall operation of the electronic device 100, application programs, and data for storage (compressed image files, videos, etc.). Additionally, the memory 140 may store preset data, an AI image, and metadata of the AI image according to various embodiments of the disclosure. At this time, the memory 140 may be a component corresponding to a memory 1130 of FIG. 11.

The image sensor 150 may capture a still image and moving images. In addition, in order to capture an image, a preview image corresponding to a preview image of an image to be captured may be provided to the processor 110. At this time, the image sensor 150 may be a camera or a component included in a camera. At this time, the image sensor 150 may be a component corresponding to a camera module 1180 of FIG. 11.

The processor 110 may be configured to include a drawing controller 111, a layer controller 112, an object analyzer 113, a prompt generator 114, an image generator 115, a depth analyzer 116, an image synthesizer 117, and an image storage 118.

At this time, a program 1140 for the drawing controller 111, the layer controller 112, the object analyzer 113, the prompt generator 114, the image generator 115, the depth analyzer 116, the image synthesizer 117, and the image storage 118 may be stored in the form of instructions in a memory 1400.

The drawing controller 111 may generate an input of a user as a drawing form. At this time, the drawing input by the user may be input into a layer, and the user may designate a drawing element such as a color, a thickness, or the like. In addition, the drawing controller 111 may change or delete the drawing form input by the user, and save the drawing form input by the user.

In addition, the drawing controller 111 may load a drawing form (template) saved in advance by the user.

The layer controller 112 controls a layer for receiving an input in the drawing form.

The layer controller 112 may fix the drawing input by the user to the layer even if a captured screen is moved. Accordingly, the layer controller 112 may move and capture the screen using a picture drawn by the user in advance.

The object analyzer 113 may analyze objects shown on the captured screen, and distinguish the type and area of each object. Also, the object analyzer 113 may analyze an object designated by the user to distinguish the type and area thereof. Additionally, the object analyzer 113 may distinguish the types and areas of surrounding objects based on drawing data of the user.

The prompt generator 114 may generate an input prompt to be used in a generative AI model using drawing input data of the user and object data obtained through the object analyzer 113. At this time, the prompt generator 114 may utilize an AI model trained to convert text input data together with the drawing input data into a prompt, and a corresponding AI model may utilize a deep learning model such as diffusion, transformer, or the like. At this time, the drawing input data corresponding to the user input may be converted into an image-type input and used, and may be converted into at least one prompt together with text input data. For example, when there are a drawing of cherry blossoms and text data such as “cherry blossoms in full bloom,” these two pieces of data may be mixed and converted into a single prompt. The prompt generated at this time may be in the form of a text or an image.

The image generator 115 may generate an image through a generative AI model using the prompt obtained through the prompt generator 114 as an input. At this time, the generative AI model may utilize a deep learning models such as Diffusion, a generative adversarial network (GAN), or the like.

The depth analyzer 116 may analyze a depth with a surrounding object based on object classification and area recognition data and user drawing data to estimate a depth of an area to be synthesized.

The image synthesizer 117 may generate an AI image by synthesizing the image generated by the image generator 115 with a preview using depth data estimated by the depth analyzer 116.

The image synthesizer 117 may request the generation of an AI image to the AI server 160 through the communicator 120, and may also receive the AI image from the AI server 160. At this time, the received AI image may have a higher resolution than that of the AI image generated through the image synthesizer 117.

The image storage 118 may store the generated AI image. Drawing input information (a drawing shape, a color, or the like), text data (data used as an auxiliary input), analyzed object information, and the used prompt, which are used in generating the AI image may be saved together with the AI image in the form of metadata. For example, when an image generated by drawing a cherry blossom tree and a bird on a leafless tree is stored, metadata of the image may include a drawing of a shape of the cherry blossom tree, a drawing form of the bird, a prompt generated by the drawing, and analyzed surrounding object information (empty branches, a tree, or the like).

The processor 110 may control the overall operation of the electronic device 100. In addition, the processor 110 may perform the functions of the drawing controller 111, the layer controller 112, the object analyzer 113, the prompt generator 114, the image generator 115, the depth analyzer 116, the image synthesizer 117, and the image storage 118. The drawing contoller 111, the layer controller 112, the prompt generator 114, the image generator 115, the depth analyzer 116, the image synthesizer 117, and the image storage 118 are separately illustrated to describe their functions separately. Accordingly, the processor 110 may include at least one processor configured to perform each function of the drawing controller 111, the layer controller 112, the object analyzer 113, the prompt generator 114, the image generator 115, the depth analyzer 116, the image synthesizer 117, and the image storage 118. In addition, the processor 110 may include at least one processor configured to perform a portion of each function of the drawing controller 111, the layer controller 112, the object analyzer 113, the prompt generator 114, the image generator 115, the depth analyzer 116, the image synthesizer 117, and the image storage 118. In this case, the processor 110 may be a component corresponding to a processor 1120 of FIG. 11.

Hereinafter, a method according to the disclosure configured as described above will be described with reference to the drawings.

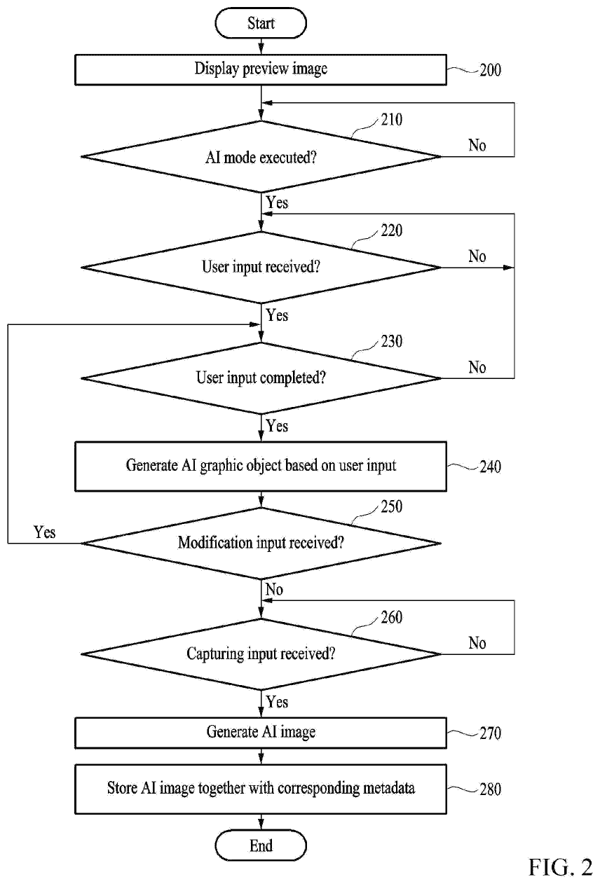

FIG. 2 is a flowchart illustrating a flow of generating an AI image according to an embodiment of the disclosure.

Referring to FIG. 2, in operation 200, the electronic device 100 may include a preview image of the image sensor 150 on the display 130.

In operation 210, the electronic device 100 may detect whether an AI mode is selected.

When the AI mode is selected as a result of the confirmation of operation 210, in operation 220, the electronic device 100 may confirm whether a user input for the preview image is received.

When the user input is received on the preview image as a result of the confirmation of operation 220, the electronic device 100 may return to operation 210 and repeat a series of operations.

When the user input for the preview image is received as a result of the confirmation of operation 220, in operation 230, the electronic device 100 may confirm whether the user input is completed. At this time, in operation 230, the electronic device 100 may determine that the user input is completed in at least one of a case where the user input is not detected for a preset period of time (e.g., when the user input (a user touch input or a pen input) is not received for 5 seconds or longer), a case where an input notifying that the user input is completed is detected, and a case where a request to generate the AI graphic object is received.

In operation 220, when a drawing input of the user or a text input of the user is received as the user input, the drawing input or the text input may be overlaid and displayed the input on the preview image. At this time, in operation 220, when a drawing mode is activated by the user input, a transparent layer, to which the drawing is input, may be added, and an input tool required for drawing may be activated. That is, when the user touches the screen with a hand or a pen, a drawing may be input into the transparent layer by considering a set color, thickness value, and the like.

In addition, in operation 220, when it is requested to call stored templates (e.g., a plurality of graphic objects), a list of the stored templates (e.g., the plurality of graphic objects) may be provided, and a template (a graphic object) selected through another user input (e.g., an input for selecting one of the stored templates) may be processed as the user input to overlay and display the selected template on the preview image. At this time, the still another user input is another input of the user, and may represent an input for selecting one of the stored templates rather than the drawing input of the user or the text input of the user.

In addition, in operation 220, the preview may not be fixed according to selection of the user, and the user input may be displayed on the transparent layer present on the preview image.

Additionally, in operation 220, the preview image may be fixed according to the selection of the user, and the user input may be displayed on the preview image. That is, in operation 220, the preview image may be captured, a graphic object corresponding to the user input may be displayed on the captured preview image, and the user input may be displayed.

Additionally, in operation 220, when an object is selected according to the selection of another user input, the user input may be displayed on the selected object included in the preview image. At this time, the other user input is another input of the user, and may represent an input for selecting an object on the displayed preview image, rather than the drawing input of the user or the text input of the user.

In other words, a drawing drawn by the user may be fixed to the transparent layer, and thus, even if the captured screen is moved, the fixed drawing may be used to fit a composition desired by the user. Alternatively, the user may capture the preview image for a moment through a captured screen fixing command, and draw a drawing on the captured preview image to fit the composition desired by the user. Alternatively, the user may designate an object, draw a drawing on the object, and fix the drawing on the object.

In operation 240, the electronic device 100 may generate at least one AI graphic object based on at least a portion of the user input, and display the at least one AI graphic object in the preview image.

In operation 250, the electronic device 100 may confirm whether a modification input of the at least one AI graphic object is received. At this time, the modification input may be an input for requesting a change to the at least one AI graphic object or an input for moving the at least one AI graphic object.

When the modification input of the at least one AI graphic object is received as a result of the confirmation of operation 250, the electronic device 100 may return to operation 230 and repeat a series of operations.

When the modification input of the at least one AI graphic object is received as a result of the confirmation of operation 250, in operation 260, the electronic device 100 may confirm whether the preview image and a capturing input corresponding to the at least one AI graphic object (an input for requesting the generation of the AI image) is received.

When the capturing input is received as a result of the confirmation of operation 260, in operation 270, the electronic device 100 may generate an AI image using an image captured using a camera based on the capturing input and the at least one AI graphic object using the user input, and display the generated AI image. At this time, the electronic device 100 may generate the AI image on its own, transmit the image captured using the camera and the at least one AI graphic object using the user input to the external AI server 160, and receive and display the generated AI image from the AI server 160.

In operation 280, the electronic device 100 may store the generated AI image together with metadata of the AI image. At this time, the metadata of the AI image may include at least one of the image captured using the camera, the at least one AI graphic object using the user input, the user input used to generate the AI image, object information included in the AI image, and a prompt used to generate the AI image.

Meanwhile, when it is requested to call a stored AI image, the electronic device 100 may load an AI image and metadata of the AI image, overlay and display the at least one AI graphic object on the preview image using the captured image included in the metadata of the AI image and the at least one AI graphic object, modify the at least one AI graphic object based on a modification input of the user, and overlay and display the modified at least one AI graphic object on the preview image.

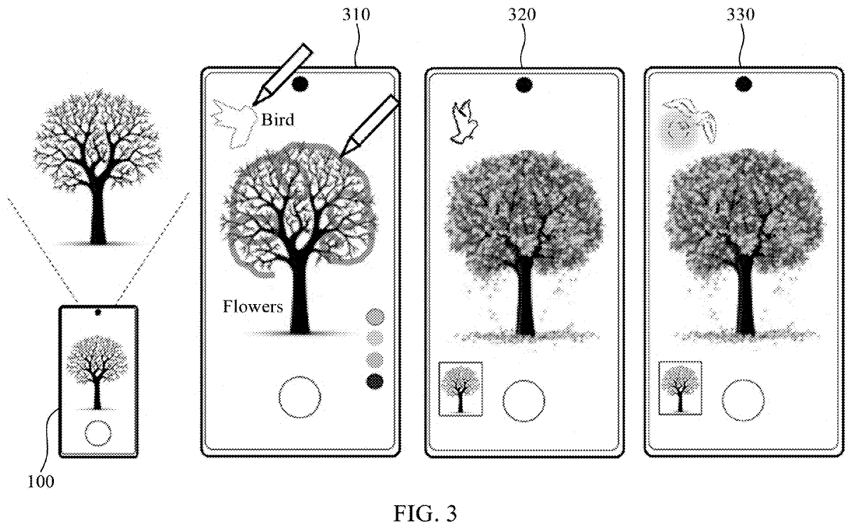

FIG. 3 is a diagram illustrating an example of generating an AI image through drawing according to an embodiment of the disclosure.

Referring to FIG. 3, a first drawing 310 shows an example in which a user input (e.g., drawing with a specific color on a tree or drawing a bird) is overlaid and displayed on a preview input through the image sensor 150 of the electronic device 100.

A second drawing 320 shows an example in which at least one AI graphic object corresponding to the user input is overlaid and displayed on a corresponding object of the preview.

A third drawing 330 shows an example in which at least one AI graphic object of a bird is selected to change it to at least one AI graphic object of a different type of bird.

The user may turn on the image sensor 150 of the electronic device 100 to capture a surrounding subject. The surrounding subject may be a preview through the display 130 of the electronic device 100. The user may add an AI graphic object through menu selection, select an AI mode for generating an AI image, generate a desired AI graphic object by drawing on the preview before image capturing as in the first drawing 310, and input a text using a text. At this time, for the input, a drawing may be drawn in advance by placing the electronic device 100 on a flat place, then, the image sensor 150 may be turned on to overlay and display the corresponding input content on the preview image, or the image sensor 150 may be turned on to compose and draw a drawing on the preview image.

For example, when the user wants to take a picture of empty branches in winter, it may be composed as the first drawing 310, flowers may be drawn at a position corresponding to a tree overlaid and displayed on the corresponding preview image, and a bird may be drawn.

When the user draws a drawing and then a predetermined period of time (e.g., 5 seconds) elapses or when the user instructs a command to terminate a drawing input, the electronic device 100 may overlay and display at least one AI graphic object corresponding to a portion of a tree in bloom on the subject as in the second drawing 320, and display an AI graphic object of a bird at the position of the bird drawn by the user. At this time, even when the user moves the composition, the overlaid AI graphic object may be overlaid and displayed by following the object. That is, the AI graphic object may correspond to the corresponding object.

For example, the user may change the position or color of the AI graphic object through a drag input or the like. For example, as in the third drawing 330, when the user does not like the bird image, the electronic device 100 may change into an AI graphic object of another bird or delete the bird image as in the third drawing 330 through an input for selecting the AI graphic object of the bird.

An image confirmed on the preview by the user may be an image generated using the processor 110 inside the electronic device 100. When the image is captured, each displayed AI graphic object may be generated as one AI image. The AI image may be generated using the processor 110 of the electronic device 100, but a high-quality AI image may also be generated using the external generative AI server 160 and displayed on the electronic device 100.

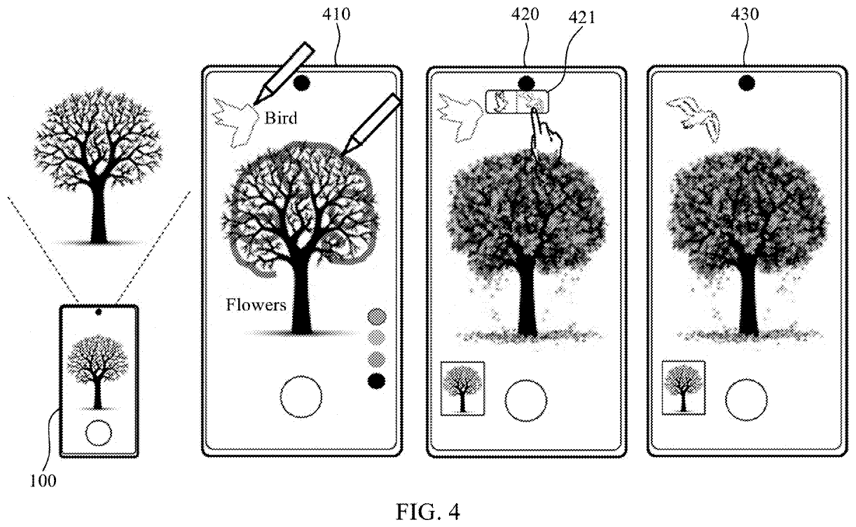

FIG. 4 is a diagram illustrating an example of generating an AI image by selecting and changing an object added by drawing among samples according to an embodiment of the disclosure.

Referring to FIG. 4, a first drawing 410 shows an example in which a user input (e.g., drawing with a specific color on a tree or drawing a bird) for a preview image input through the image sensor 150 of the electronic device 100 is overlaid and displayed.

A second drawing 420 shows an example in which an AI graphic object corresponding to a portion of a tree in bloom is overlaid and displayed on a subject and an AI graphic object of a bird is selected through a selection window 421.

A third drawing 430 shows an example in which the AI graphic object corresponding to the portion of a tree in bloom is overlaid and displayed on the subject and the AI graphic object of a bird is overlaid and displayed on the preview image.

That is, the electronic device 100 may provide the user with candidate AI graphic objects that may be generated after inputting a drawing of a bird as shown in the second drawing 420, through a user interface such as the selection window 421. Then, when a command to capture is received, the electronic device 100 may generate an AI image to which the third drawing 430 is applied.

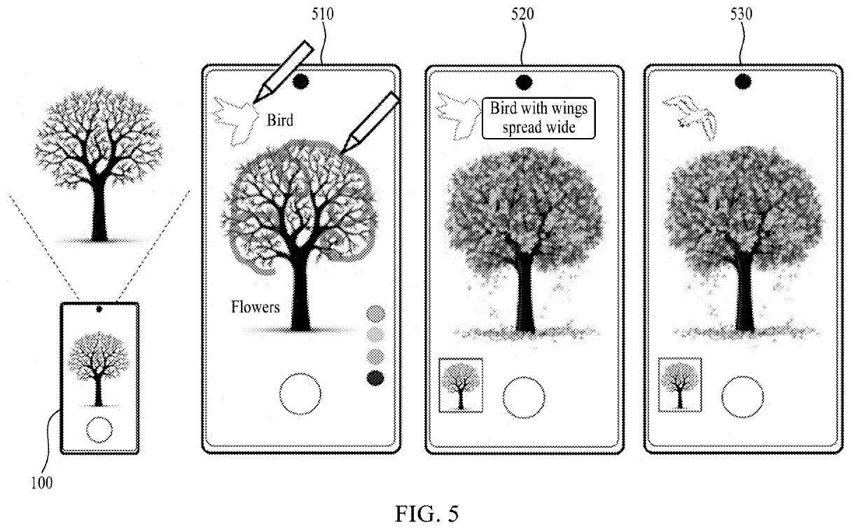

FIG. 5 is a diagram illustrating an example of generating an AI image by changing an object added by drawing by inputting a text according to an embodiment of the disclosure.

Referring to FIG. 5, a first drawing 510 shows an example in which a user input (e.g., drawing with a specific color on a tree or drawing a bird) for a preview image input through the image sensor 150 of the electronic device 100 is overlaid and displayed.

A second drawing 520 shows an example in which an AI graphic object corresponding to a portion of a tree in bloom is overlaid and displayed on a subject, a bird is drawn, and then, a specific shape of the bird is input as a text before the AI graphic object for the bird is generated.

A third drawing 530 shows an example in which the AI graphic object corresponding to the portion of a tree in bloom is overlaid and displayed on the subject and the AI graphic object of the bird is overlaid and displayed on the subject.

That is, when it is determined that information is insufficient with only the drawing input as in the second drawing 520, the user may additionally add text information together with the drawing to specify a drawing object, thereby generating an AI image that specifically reflects a user intent.

Accordingly, the electronic device 100 may provide the user with a user interface to which a text may be input. When the text is input, the electronic device 100 may use corresponding text data together with drawing information to generate a prompt. At this time, the text input may be performed directly by the user as a key input through a key input user interface displayed on the electronic device 100, or may be performed through a voice using a technology such as Speech-to-Text.

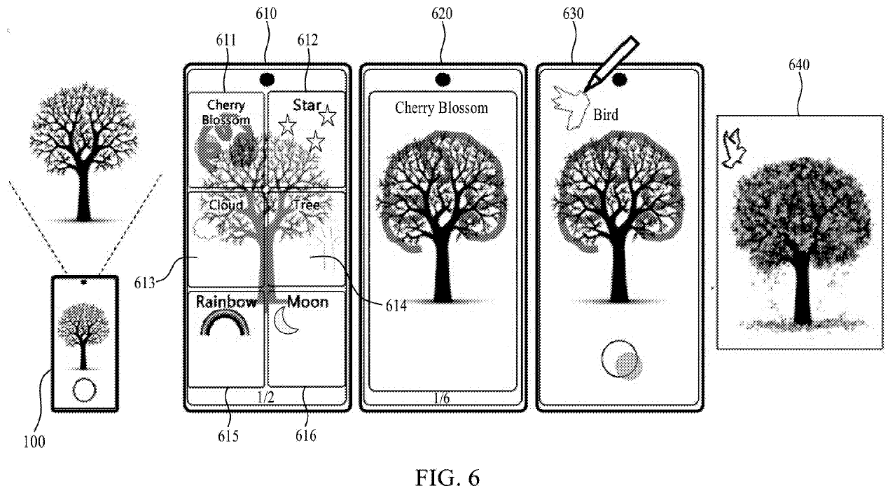

FIG. 6 is a diagram illustrating an example of generating an AI image using a stored template according to an embodiment of the disclosure.

Referring to FIG. 6, a first drawing 610 shows an example in which presets 611, 612, 613, 614, 615, and 616 stored in advance corresponding to a graphic object are output onto a preview image input through an image sensor 150 of an electronic device 100.

A second drawing 620 shows an example in which the preset 611 is selected from among the stored presets 611, 612, 613, 614, 615, and 616 and overlaid and displayed on the preview input through the image sensor 150 of the electronic device 100.

A third drawing 630 shows an example in which the selected preset 611 is overlaid and displayed on the preview and a bird drawn by the user is overlaid and displayed on the preview.

A fourth drawing 640 shows an example in which the preset 611 corresponding to the user input and at least one AI graphic object for the drawn bird are overlaid and displayed on the corresponding object in the preview.

That is, the electronic device 100 may store various presets in the memory 140. At this time, the presets may be provided by a manufacturer of the electronic device 100, supplied by a separate business operator that supplies presets, or may be generated and stored in advance by the user of the electronic device 100.

The user may additionally draw or modify images on a set preset. For example, a bird shape may be drawn additionally onto the preset 611 corresponding to the cherry blossom drawing loaded as in the third drawing 630. When the user completes drawing and instructs a command to capture, the electronic device 100 may generate a prompt based on the preset and the drawing, generate at least one AI graphic object using the prompt, and generate an AI image such as the fourth drawing 640 using analyzed depth information.

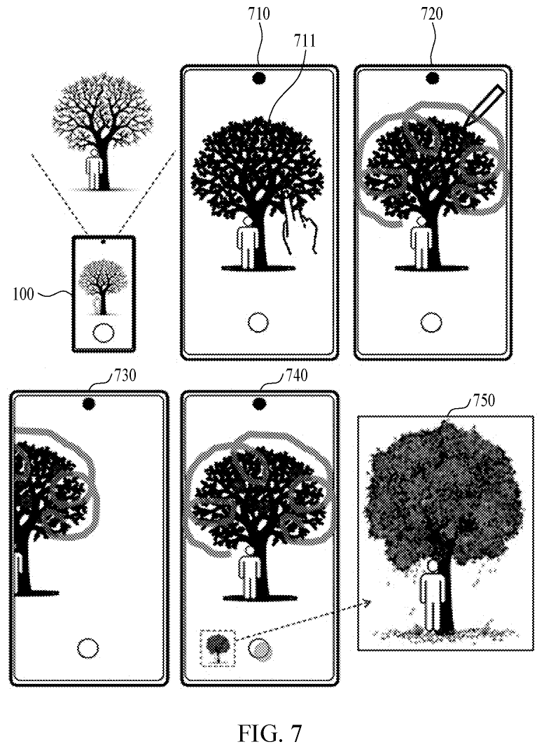

FIG. 7 is a diagram illustrating an example of generating an AI image by designating an object to be drawn according to an embodiment of the disclosure.

Referring to FIG. 7, a first drawing 710 shows an example in which a tree 711, which is an object to which drawing is to be applied, is designated in a preview input through the image sensor 150 of the electronic device 100.

A second drawing 720 shows an example in which fruits and leaves input by drawing are overlaid and displayed on the object in the preview image. At this time, the fruits and leaves input by drawing may be positioned corresponding to the selected object, the tree.

A third drawing 730 is an example showing that, even if the composition of the preview image is changed, the drawing of the fruits and leaves is positioned corresponding to the object since the drawing is performed by designating the object.

A fourth drawing 740 shows an example in which even if the composition of the preview image is restored to the original state, the drawing of the fruits and leaves is positioned corresponding to the designated object.

A fifth drawing 750 shows an example in which AI graphic objects corresponding to drawing of the fruits and leaves are overlaid and displayed on the object in the preview image.

FIG. 7 may show that, in a situation where the user is taking a picture of a person with a tree that has not yet borne fruits, when the user composes the drawing and instructs a command to designate the tree 711 displayed on the preview image, as in the first drawing 710, the object is designated (e.g., a thick outline indicating that it is designated is displayed). A portion of fruits and leaves may be drawn on the tree object designated by the user as in the second drawing 720. At this time, the overlaid drawing corresponding to the designated object may be displayed by following the designated object even when the user moves the composition, as in the third drawing 730. Based on the drawing information drawn by the user, a related prompt may be automatically generated using information on the designated object. Additionally, depth information may be analyzed based on the designated object and utilized to synthesize an image at an appropriate depth during image synthesis. When the user completes drawing and instructs a command to capture, an AI image may be generated using the designated object information and the drawing information input by the user, and an AI image may be generated as in the fifth drawing 750 through synthesis. Additionally, if the user designates an object incorrectly, the object designation may be canceled. When the object designation is canceled, the drawing may be deleted or maintained, and the drawing may be displayed without following the canceled designated object.

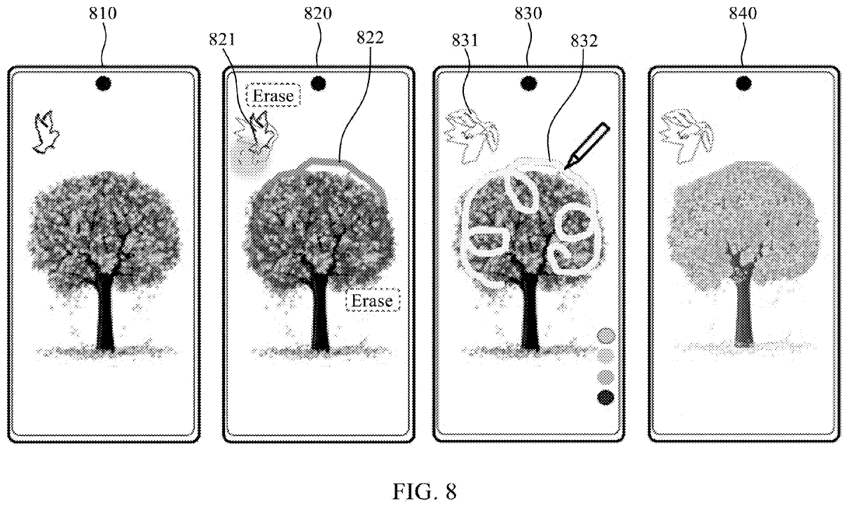

FIG. 8 is a diagram illustrating an example of modifying an AI image by loading a stored AI image according to an embodiment of the disclosure.

Referring to FIG. 8, a first drawing 810 is an example in which an AI image stored in the memory 140 of the electronic device 100 is loaded, and is an AI image with a portion of a tree in bloom and a bird added.

A second drawing 820 shows an example in which, when the AI image stored in the memory 140 of the electronic device 100 is loaded, drawing information 821 and 822 of the user are overlaid and displayed on the AI image from corresponding metadata stored together with the AI image.

A third drawing 830 shows an example in which drawing information 831 and 832 are selected to change the drawing information 821 and 822. For example, the user may select the drawing information 831 to change the shape of the bird, and change a color of the drawing information 832 to change the color of leaves.

A fourth drawing 840 shows an example of the AI graphic object that is changed according to the changes in the drawing information 821 and 822.

That is, when the user instructs a command to load an AI image generated and stored by a method according to various embodiments of the disclosure as in the first drawing 810, metadata stored together with the AI image may be loaded. At this time, since the metadata stores drawing data and text data that have been input by the user, object information that has been analyzed, a prompt that has been generated, and the like, the drawing drawn by the user and the designated object may be overlaid and displayed on an AI image generated using the metadata as in the second drawing 820 above. When the user wants to edit an image generated for a loaded image, each of the generated image and drawing may be modified. For example, when the user wants to edit an image of a bird generated by drawing, the image may be changed to another bird image as in the third picture 830 above through a user input for the generated bird as in the second drawing 820 above, or may be deleted through a delete command. In addition, when the user wants to change the drawing shape of the generated image to change the image into a new AI image, the user may change the color of the input drawing as in the third drawing 830. Additionally, the shape of the drawing of the user may be changed or an existing drawing may be deleted and a new drawing may be input.

When the user instructs a command to complete the modification, a modified AI image may be generated as in the fourth drawing 840 using the new information. When the user inputs a command to complete the modification, the modified image and metadata are stored.

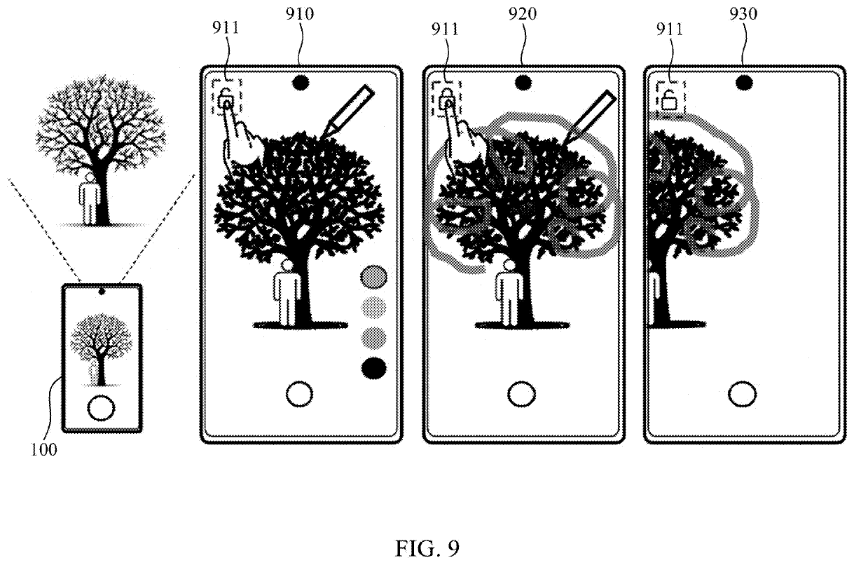

FIG. 9 is a diagram illustrating an example of fixing a preview and generating an AI image through drawing according to an embodiment of the disclosure.

Referring to FIG. 9, a first drawing 910 shows an example in which a preview image is fixed using a button (e.g., a pause button 911) before applying drawing in the preview input through the image sensor 150 of the electronic device 100.

A second drawing 920 shows an example in which the preview image is captured using the pause button 911 and tree fruits and leaves are drawn on the captured preview image.

A third drawing 930 shows an example in which, when the pause button 911 is released to release the fixation of the preview image, the image drawn in the fixed state is fixed to an object and remains fixed to the object even if the composition of the preview image is changed.

That is, the user may pause a screen shown in the preview image for a moment (so that the screen is fixed without moving according to a terminal moving), and a drawing may be input to generate an AI image. For example, in a situation where the user is taking a picture of a person with a tree that has not yet borne fruits, when the user composes the drawing and inputs the pause button 911 for fixing a preview screen as in the first drawing 910, the preview screen may be fixed as in the second drawing 920, indicating that the preview screen is fixed. By using this, in a situation where the user has difficulty drawing due to shaking, the preview screen may be fixed for a moment, the user may complete drawing, and then, when the user instructs a command to release captured preview fixation, the screen may return to a moving preview screen as in the third drawing 630. At this time, if the user draws by designating an object as in the embodiment described above, the drawing may move along the object as in the fourth drawing above, and if the user does not draw by designating an object, the input drawing may move along the preview screen.

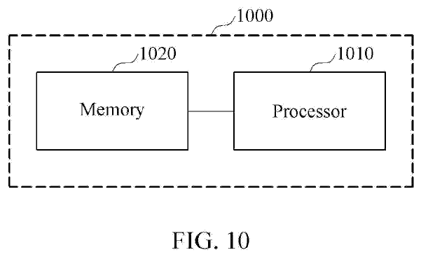

FIG. 10 is a diagram illustrating a schematic configuration of an electronic device for generating an AI image according to an embodiment of the disclosure.

Referring to FIG. 10, an electronic device 1000 may include a processor 1010 and a memory 1020.

The memory 1020 may store an OS, an application program, and storage data for controlling the overall operation of the electronic device 1000. Additionally, the memory 1020 may store preset data, AI images, and metadata of the AI images according to various embodiments of the disclosure.

The processor 1010 may correspond to the processor 110 of the electronic device 100 of FIG. 1. Meanwhile, the processor 1210 may include the configuration of the processor 110 of FIG. 1.

The processor 1010 may display a preview generated through a camera on a display, when a user input for the preview image is received, generate at least one AI graphic object based on the user input, and overlay the at least one AI graphic object on the preview image, and display the image on the display.

When a capturing input corresponding to the preview image and the at least one AI graphic object is received, the processor 1010 may generate an AI image using the preview image and the at least one AI graphic object, and store the AI image together with metadata of the AI image in the memory 1020.

At this time, the metadata of the AI image may include at least one of the preview image, the at least one AI graphic object, a user input used to generate the AI image, object information included in the AI image, and a prompt used to generate the AI image.

The processor 1010 may display a graphic object corresponding to the user input. At this time, the user input may include a drawing input and a text input.

When selection of a template (a plurality of graphic objects) stored in the memory 1020 is received by still another user input, the processor 1010 may display the selected template (graphic objects) on a preview image. More specifically, the processor 1010 may display a plurality of graphic objects for generating the at least one AI graphic object, and when still another user input for selecting a graphic object among the plurality of graphic objects is received, display the selected graphic object on the preview image.

When receiving a user input, the processor 1010 may fix the preview image, and display the user input on the preview image on the display. More specifically, the processor 1010 may capture the preview image, and display a graphic object corresponding to the user input on the captured preview image.

When receiving a user input, the processor 1010 may not fix the preview image, and may display the user input on a transparent layer present over the preview image on the display.

When receiving a user input, the processor 1010 may receive another user input for selecting an object in the preview image, and display the user input for the object selected in the preview image.

When receiving a user input, the processor 1010 may determine that the user input is completed in at least one of a case where the user input is not detected for a preset period of time, a case where an input notifying that the user input is completed is detected, and a case where a request to generate the at least one AI graphic object is received.

When overlaying the at least one AI graphic object on the preview image and displaying the image on the display, the processor 1010 may change or move the at least one AI graphic object based on another user input.

When generating an AI image, the processor 1010 may transmit the preview image and the at least one AI graphic object to an external AI server, receive the AI image from the external AI server, and display the AI mage on the display.

When a request is made to call an AI image stored in the memory, the processor 1010 may load an AI image and metadata of the AI image from the memory, use a preview image and at least one AI graphic object included in the metadata of the AI image to overlay the at least one AI graphic object on the preview image and display the image on the display, modify the at least one AI graphic object based on a modification input of the user, overlay the modified at least one AI graphic object on the preview image, and display the image on the display.

FIG. 11 is a block diagram illustrating an electronic device in a network environment according to an embodiment of the disclosure.

Referring to FIG. 11, an electronic device 1101 in a network environment 1100 may communicate with an electronic device 1102 via a first network 1198 (e.g., a short-range wireless communication network), or communicate with at least one of an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120, memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module (SIM) 1196, or an antenna module 1197. In an embodiment, at least one of the components (e.g., the connecting terminal 1178) may be omitted from the electronic device 1101, or one or more other components may be added to the electronic device 1101. In an embodiment, some of the components (e.g., the sensor module 1176, the camera module 1180, or the antenna module 1197) may be integrated into a single component (e.g., the display module 1160).

The processor 1120 may execute, for example, software (e.g., a program 1140) to control at least one other component (e.g., a hardware or software component) of the electronic device 1101 connected to the processor 1120 and may perform various data processing or computation. According to an embodiment, as at least part of the data processing or computation, the processor 1120 may store a command or data received from another component (e.g., the sensor module 1176 or the communication module 1190) in volatile memory 1132, process the command or the data stored in the volatile memory 1132, and store resulting data in non-volatile memory 1134.

Meanwhile, the processor 1120 may perform the operation of the processor 110 of FIG. 1 or the operation of the processor 1010 of FIG. 10.

According to an embodiment, the processor 1120 may include a main processor 1121 (e.g., a central processing unit (CPU) or an application processor (AP)), or an auxiliary processor 1123 (e.g., a graphics processing unit (GPU), a neural processing unit (NPU), an image signal processor (ISP), a sensor hub processor, or a communication processor (CP)) that is operable independently from, or in conjunction with, the main processor 1121. For example, when the electronic device 1101 includes the main processor 1121 and the auxiliary processor 1123, the auxiliary processor 1123 may be adapted to consume less power than the main processor 1121 or to be dedicated for a designated function. The auxiliary processor 1123 may be implemented separately from the main processor 1121 or as a part of the main processor 1121.

The auxiliary processor 1123 may control at least some of functions or states related to at least one (e.g., the display module 1160, the sensor module 1176, or the communication module 1190) of the components of the electronic device 1101, instead of the main processor 1121 while the main processor 1121 is in an inactive (e.g., sleep) state, or together with the main processor 1121 while the main processor 1121 is an active state (e.g., executing an application). According to an embodiment, the auxiliary processor 1123 (e.g., an ISP or a CP) may be implemented as part of another component (e.g., the camera module 1180 or the communication module 1190) functionally related to the auxiliary processor 1123. According to an embodiment, the auxiliary processor 1123 (e.g., the NPU) may include a hardware structure specified for AI model processing. An AI model may be generated through machine learning. Such learning may be performed, e.g., by the electronic device 1101 where the AI model is performed or via a separate server (e.g., the server 1108). Learning algorithms may include, but are not limited to, e.g., supervised learning, unsupervised learning, semi-supervised learning, or reinforcement learning. The AI model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof, but is not limited thereto. The AI model may, additionally or alternatively, include a software structure other than the hardware structure.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

Meanwhile, the memory 1130 may serve as the memory 140 of FIG. 1 or the memory 1020 of FIG. 10.

The program 1140 may be stored in the memory 1130 as software, and may include, for example, an OS 1142, middleware 1144, or an application 1146.

The input module 1150 may receive a command or data to be used by another component (e.g., the processor 1120) of the electronic device 1101, from the outside (e.g., a user) of the electronic device 1101. The input module 1150 may include, for example, a microphone, a mouse, a keyboard, a key (e.g., a button), or a digital pen (e.g., a stylus pen).

The sound output module 1155 may output a sound signal to the outside of the electronic device 1101. The sound output module 1155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1160 may visually provide information to the outside (e.g., a user) of the electronic device 1101. The display module 1160 may include, for example, a display, a hologram device, or a projector and control circuitry to control a corresponding one of the display, the hologram device, and the projector. According to an embodiment, the display module 1160 may include a touch sensor adapted to detect a touch, or a pressure sensor adapted to measure the intensity of force incurred by the touch. In this case, the display module 1160 may serve as the display 130 of FIG. 1.

The audio module 1170 may convert a sound into an electrical signal or vice versa. According to an embodiment, the audio module 1170 may obtain the sound via the input module 1150, or output the sound via the sound output module 1155 or an external electronic device (e.g., the electronic device 1102) (e.g., a speaker or a headphone) directly or wirelessly coupled with the electronic device 1101.

The sensor module 1176 may detect an operational state (e.g., power or temperature) of the electronic device 1101 or an environmental state (e.g., a state of a user) external to the electronic device 1101, and generate an electrical signal or data value corresponding to the detected state. According to an embodiment, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device (e.g., the electronic device 1102) directly (e.g., wiredly) or wirelessly. According to an embodiment, the interface 1177 may include, for example, a high definition multimedia interface (HDMI), a universal serial bus (USB) interface, a secure digital (SD) card interface, or an audio interface.

The connecting terminal 1178 may include a connector via which the electronic device 1101 may be physically connected to an external electronic device (e.g., the electronic device 1102). According to an embodiment, the connecting terminal 1178 may include, for example, an HDMI connector, a USB connector, an SD card connector, or an audio connector (e.g., a headphone connector).

The haptic module 1179 may convert an electric signal into a mechanical stimulus (e.g., a vibration or a movement) or an electrical stimulus which may be recognized by a user via his or her tactile sensation or kinesthetic sensation. According to an embodiment, the haptic module 1179 may include, for example, a motor, a piezoelectric element, or an electric stimulator.

The camera module 1180 may capture a still image and moving images. According to an embodiment, the camera module 1180 may include one or more lenses, image sensors, ISPs, or flashes. In this case, the camera module 1180 may serve as the image sensor 150 of FIG. 1.

The power management module 1188 may manage power supplied to the electronic device 1101. According to an embodiment, the power management module 1188 may be implemented as at least part of, for example, a power management integrated circuit (PMIC).

The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more CPs that are operable independently from the processor 1120 (e.g., the AP) and support a direct (e.g., wired) communication or a wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device 1104 via the first network 1198 (e.g., a short-range communication network, such as Bluetooth™, wireless-fidelity (Wi-Fi) direct, or infrared data association (IrDA)) or the second network 1199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 1192 may identify and authenticate the electronic device 1101 in a communication network, such as the first network 1198 or the second network 1199, using subscriber information (e.g., international mobile subscriber identity (IMSI)) stored in the SIM 1196. The communication module 1190 may serve as the communicator 120 of FIG. 1.

The wireless communication module 1192 may support a 5G network, after fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., the millimeter wave (mmWave) band) to achieve, e.g., a high data transmission rate. The wireless communication module 1192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1192 may support various requirements specified in the electronic device 1101, an external electronic device (e.g., the electronic device 1104), or a network system (e.g., the second network 1199). According to an embodiment, the wireless communication module 1192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 1197 may transmit or receive a signal or power to or from the outside (e.g., an external electronic device) of the electronic device 1101. According to an embodiment, the antenna module 1197 may include an antenna including a radiating element composed of a conductive material or a conductive pattern formed in or on a substrate (e.g., a printed circuit board (PCB)). According to an embodiment, the antenna module 1197 may include a plurality of antennas (e.g., array antennas). In such a case, at least one antenna appropriate for a communication scheme used in a communication network, such as the first network 1198 or the second network 1199, may be selected by, for example, the communication module 1190 from the plurality of antennas. The signal or power may be transmitted or received between the communication module 1190 and the external electronic device via the at least one selected antenna. According to an embodiment, another component (e.g., a radio frequency integrated circuit (RFIC)) other than the radiating element may be additionally formed as part of the antenna module 1197.

According to an embodiment, the antenna module 1197 may form a mmWave antenna module. According to an embodiment, the mmWave antenna module may include a PCB, a RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the components described above may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1101 and the external electronic device 1104 via the server 1108 coupled with the second network 1199. Each of the external electronic devices 1102 or 1104 may be a device of a same type as, or a different type, from the electronic device 1101. According to an embodiment, all or some of operations to be executed by the electronic device 1101 may be executed by one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To that end, cloud computing, distributed computing, mobile edge computing (MEC), or client-server computing technology may be used, for example. The electronic device 1101 may provide ultra low-latency services using, e.g., distributed computing or mobile edge computing. In another embodiment, the external electronic device 1104 may include an Internet-of-Things (IoT) device. The server 1108 may be an intelligent server using machine learning and/or a neural network. According to an embodiment, the external electronic device 1104 or the server 1108 may be included in the second network 1199. The electronic device 1101 may be applied to intelligent services (e.g., smart home, smart city, smart car, or healthcare) based on 5G communication technology or IoT-related technology.

The electronic device according to an embodiment may be one of various types of electronic devices. The electronic device may include, for example, a portable communication device (e.g., a smartphone), a computer device, a portable multimedia device, a portable medical device, a camera, a wearable device, or a home appliance. According to an embodiment of the disclosure, the electronic device is not limited to those described above.

It should be appreciated that an embodiment of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. As used herein, such terms as “1st” and “2nd,” or “first” and “second” may be used to simply distinguish a corresponding component from another, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment as set forth herein may be implemented as software (e.g., the program 1140) including one or more instructions that are stored in a storage medium (e.g., internal memory 1136 or external memory 1138) that is readable by a machine (e.g., the electronic device 1101). For example, a processor (e.g., the processor 1120) of the machine (e.g., the electronic device 1101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment disclosed herein may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

According to an embodiment, an electronic device 100; 1000; 1100 may include an image sensor 150; 1180; a display 130; 1160; and a processor 110; 1010; 1120. The processor 110; 1010; 1120 may be configured to display a preview image obtained from the image sensor 150; 1180 through the display 130; 1160, receive a user input for the preview image through the display 130; 1160, generate at least one AI graphic object based on at least a portion of the user input, display the at least one AI graphic object on the preview image, and generate an AI image based on an image captured in response to another user input and at least a portion of the at least one AI graphic object.

According to an embodiment, the processor 110; 1010; 1120 may be configured to store the AI image together with metadata of the AI image, and the metadata of the AI image may include at least one of the captured image, the at least one AI graphic object, the user input used to generate the at least one AI graphic object, object information included in the AI image, and a prompt used to generate the AI image.

According to an embodiment, the processor 110; 1010; 1120 may be configured to, when the user input for the preview image is received, display a graphic object corresponding to the user input, and the user input may include a drawing input or a text input.

According to an embodiment, the processor 110; 1010; 1120 may be configured to, when receiving the user input, display a plurality of graphic objects for generating the at least one AI graphic object, and receive still another user input for selecting a graphic object among the plurality of graphic objects.

According to an embodiment, the processor 110; 1010; 1120 may be configured to, when receiving the user input, capture the preview image, and display a graphic object corresponding to the user input on the captured preview image.

According to an embodiment, the processor 110; 1010; 1120 may be configured to, when receiving the user input, receive another user input for selecting an object in the preview image, and display the user input for the object on the preview image.

According to an embodiment, the processor 110; 1010; 1120 may be configured to, when receiving the user input, determine that the user input is completed in at least one of a case where the user input is not detected for a preset period of time, a case where an input notifying that the user input is completed is detected, and a case where a request to generate the at least one AI graphic object is received.

According to an embodiment, the processor 110; 1010; 1120 may be configured to, when displaying the at least one AI graphic object on the preview image, change or move the at least one AI graphic object based on another user input.

According to an embodiment, the processor 110; 1010; 1120 may be configured to, when generating the AI image, transmit the captured image and the at least one AI graphic object to an external AI server, receive the AI image from the external AI server, and display the AI image.

According to an embodiment, a method of generating an AI image may include displaying a preview image of a camera 150; 1180 on a display 130; 1160; receiving a user input for the preview image; generating at least one AI graphic object based on at least a portion of the user input; and displaying the at least one AI graphic object on the preview image.

According to an embodiment, the method may further include, when a capturing input for the preview image is received, generating an AI image using an image captured based on the capturing input and the at least one AI graphic object.

According to an embodiment, the method may further include storing the generated AI image together with metadata of the AI image, and the metadata of the AI image may include at least one of the captured image, the at least one AI graphic object, the user input used to generate the at least one AI graphic object, object information included in the AI image, and a prompt used to generate the AI image.

According to an embodiment, the receiving of the user input for the preview image may include displaying a graphic object corresponding to the user input, and the user input may include a drawing input or a text input.

According to an embodiment, the receiving of the user input for the preview image may include displaying a plurality of graphic objects for generating the at least one AI graphic object; and receiving still another user input for selecting a graphic object among the plurality of graphic objects.

According to an embodiment, the receiving of the user input for the preview image may include capturing the preview image, and displaying a graphic object corresponding to the user input on the captured preview image.

According to an embodiment, the receiving of the user input for the preview image may include receiving another user input for selecting an object in the preview image, and displaying the user input for the object on the preview image.

According to an embodiment, the receiving of the user input for the preview image may include determining that the user input is completed in at least one of a case where the user input is not detected for a preset period of time, a case where an input notifying that the user input is completed is detected, and a case where a request to generate the at least one AI graphic object is received.

According to an embodiment, the displaying of the at least one AI graphic object on the preview image may include changing or moving the at least one AI graphic object based on another user input.

According to an embodiment, the generating of the AI image using the captured image and the at least one AI graphic object may include transmitting the captured image and the at least one AI graphic object to an external AI server; receiving the AI image from the external AI server; and displaying the AI image.

The method according to the embodiments described above may be recorded in non-transitory computer-readable storage media including program instructions to implement various operations of the embodiments described above. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable storage media include magnetic media such as hard disks, floppy disks, and magnetic tape; optical media such as compact disc read-only memory (CD-ROM) discs and digital video discs (DVDs); magneto-optical media such as floptical disks; and hardware devices that are specifically configured to store and perform program instructions, such as ROM, random-access memory (RAM), flash memory, and the like. Examples of program instructions include both machine code, such as produced by a compiler, and files containing higher-level code that may be executed by the computer using an interpreter. The above-described hardware devices may be configured to act as one or more software modules in order to perform the operations of the above-described embodiments, or vice versa.

Software may include a computer program, a piece of code, an instruction, or one or more combinations thereof, to independently or collectively instruct or configure a processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made in therein without departing from the spirit and scope of the disclosure as defined by the appended claims and their equivalents.

What is claimed is:

1. An electronic device comprising:
an image sensor;
a display;
memory, comprising one or more storage media, storing one or more computer programs; and
one or more processors communicatively coupled to the image sensor, the display, and the memory,
wherein the one or more computer programs include computer-executable instructions that, when executed by the one or more processors individually or collectively, cause the electronic device to:
display a preview image obtained from the image sensor on the display,
receive a first user input for the preview image through the display,
generate at least one artificial intelligence (AI) graphic object based on at least a portion of the first user input,
display the at least one AI graphic object on the preview image, and
generate an AI image based on an image captured in response to a second user input and at least a portion of the at least one AI graphic object.

2. The electronic device of claim 1,
wherein the one or more computer programs further include computer-executable instructions that, when executed by the one or more processors individually or collectively, cause the electronic device to store the AI image together with metadata of the AI image in the memory, and
wherein the metadata of the AI image comprises at least one of the captured image, the at least one AI graphic object, the first user input, object information included in the AI image, and a prompt corresponding to the second user input.

3. The electronic device of claim 1,
wherein the one or more computer programs further include computer-executable instructions that, when executed by the one or more processors individually or collectively, cause the electronic device to, when the first user input is received, display a graphic object corresponding to the first user input, and
wherein the first user input comprises a drawing input or a text input.

4. The electronic device of claim 1, wherein the one or more computer programs further include computer-executable instructions that, when executed by the one or more processors individually or collectively, cause the electronic device to:
when receiving the first user input, display a plurality of graphic objects for generating the at least one AI graphic object; and
receive a third user input for selecting a graphic object among the plurality of graphic objects.

5. The electronic device of claim 1, wherein the one or more computer programs further include computer-executable instructions that, when executed by the one or more processors individually or collectively, cause the electronic device to:
when receiving the first user input, capture the preview image; and
display a graphic object corresponding to the first user input on the preview image.

6. The electronic device of claim 1, wherein the one or more computer programs further include computer-executable instructions that, when executed by the one or more processors individually or collectively, cause the electronic device to:
when receiving the first user input, receive a fourth user input for selecting an object in the preview image; and
display the fourth user input for the object on the preview image.

7. The electronic device of claim 1, wherein the one or more computer programs further include computer-executable instructions that, when executed by the one or more processors individually or collectively, cause the electronic device to:
when receiving the first user input, determine that the first user input is completed when the first user input is not detected for a preset period of time, when an input notifying that the first user input is completed is detected, or when a request to generate the at least one AI graphic object is received.

8. The electronic device of claim 1, wherein the one or more computer programs further include computer-executable instructions that, when executed by the one or more processors individually or collectively, cause the electronic device to:
when displaying the at least one AI graphic object on the preview image, change or move the at least one AI graphic object based on a fifth user input.

9. The electronic device of claim 1, wherein the one or more computer programs further include computer-executable instructions that, when executed by the one or more processors individually or collectively, cause the electronic device to:
when generating the AI image, transmit the captured image and the at least one AI graphic object to an external AI server,
receive the AI image from the external AI server; and
display the AI image.

10. A method performed by an electronic device with a display, the method comprising:
displaying a preview image of a camera on the display;
receiving a first user input for the preview image;
generating at least one artificial intelligence (AI) graphic object based on at least a portion of the first user input; and
displaying the at least one AI graphic object on the preview image.

11. The method of claim 10, further comprising:
when a second user input configured as a capturing input for the preview image is received, generating an AI image using an image captured based on the second user input and the at least one AI graphic object.

12. The method of claim 11, further comprising:
storing the generated AI image together with metadata of the AI image in memory of the electronic device,
wherein the metadata of the AI image comprises at least one of the captured image, the at least one AI graphic object, the first user input, object information included in the AI image, and a prompt corresponding to the second user input.

13. The method of claim 10, further comprising:
after the receiving of the first user input for the preview image, displaying a graphic object corresponding to the first user input,
wherein the first user input comprises a drawing input or a text input.

14. The method of claim 10, further comprising:
after the receiving of the first user input for the preview image, displaying a plurality of graphic objects for generating the at least one AI graphic object; and
receiving a third user input for selecting a graphic object among the plurality of graphic objects.

15. The method of claim 10, further comprising:
after the receiving of the first user input for the preview image, capturing the preview image; and
displaying a graphic object corresponding to the first user input on the preview image.

16. The method of claim 10, further comprising:
after receiving the first user input, receiving a fourth user input for selecting an object in the preview image; and
displaying the fourth user input for the object on the preview image.

17. The method of claim 10, further comprising:
after receiving the first user input, determining that the first user input is completed when the first user input is not detected for a preset period of time, when an input notifying that the first user input is completed is detected, or when a request to generate the at least one AI graphic object is received.

18. The method of claim 10, further comprising:
after displaying the at least one AI graphic object on the preview image, changing or moving the at least one AI graphic object based on a fifth user input.

19. The method of claim 11, further comprising:
when generating the AI image, transmitting the captured image and the at least one AI graphic object to an external AI server,
receiving the AI image from the external AI server; and
displaying the AI image on the display of the electronic device.

20. One or more non-transitory computer-readable storage media storing one or more computer programs including computer-executable instructions that, when executed by one or more processors of an electronic device individually or collectively, cause the electronic device to perform operations, the operations comprising:
displaying a preview image obtained from an image sensor of the electronic device on a display of the electronic device;
receiving a first user input for the preview image through the display;
generating at least one artificial intelligence (AI) graphic object based on at least a portion of the first user input;
displaying the at least one AI graphic object on the preview image; and
generating an AI image based on an image captured in response to a second user input and at least a portion of the at least one AI graphic object.
